(19) United States
(12) Patent Application Publication
(10) Pub. No.: US 2008/0136776 A1
(43) Pub. Date: Jun. 12, 2008

(54) Method and Device for Touch Free Operation

(76) Inventor: Timo Valkas, Karkkila (FI)

Correspondence Address: JOEL D. SKINNER, JR.;SKINNER AND ASSOCIATES, 212 COMMERCIAL ST., HUDSON, WI, 54016, US

(21) Appl. No.: 11/793,316

(22) PCT Filed: Oct. 9, 2006
(86) PCT No.: PCT/FI06/00328

§ 371 Date: Feb. 11, 2008

(30) Foreign Application Priority Data
Oct. 14, 2005 (FI) 20051036

(51) Int. Cl. G06F 3/033; G06F 3/048

(52) U.S. Cl. 345/157

(57) ABSTRACT

Method for touch-free operation, in which light is transmitted and the reflected component of the transmitted light is received, in order to active a function. The light is sent from at least two directions, in such a way that the light beams intersect at essentially the desired operating area and the desired intended function is activated only once the light beams are detected from the reflected light. The invention also relates to a device for implementing the method.

The present invention relates to a method and device for touch-free operation. More specifically, the invention relates to a method and device, with the aid of which specific selections can be made from a display screen or corresponding device, without requiring the use of physical buttons or touching the actual display screen.

Devices similar to that described above are known in the field. In some known devices there is a display screen, which is used to make specific selections, but the selections are made by touching the screen, the change in the electrical properties of which activate the function referred to.

Light sources and sensors operating in the infrared range have also been used for various operations in many fields of technology. One field is, for example, the measurement of distance with the aid of infrared-range light. Operation is mainly based on measuring distance with the aid of the back-scattered light. In another system, operation is based on preventing a light beam from reaching a receiver, by bringing a finger or a corresponding tool to the operating point.

Systems are also known, in which infrared light is used to activate specific functions, for example, from a glass plate. In such systems, there is usually also an IR-light transmitting and receiving unit. A light beam, sent by a transmitter on the other side of the glass plate to the user, is directed towards the plate and, if the user brings an obstacle, such as a finger, into the immediate vicinity of the plate, which obstacle causes the light to be reflected to the receiver, the desired function is initiated.

The basic intention of the present invention is a form of operation of the last-mentioned type, but the intention is also to avoid the weaknesses and drawbacks of the said solution and other solutions of a similar type, which often cause erroneous operation and an imprecision of use, which causes, for example, a specific function to be selected unintentionally, due to the fact that the equipment lacks depth precision so that the function is triggered by some obstacle farther away, which nevertheless causes a sufficient reflection to activate the function. The intention is also to create an operating situation, in which the user can access a function even on a display screen, from a location directly above the symbol depicting the function, which has not been possible in earlier known devices.

Thus, the invention is intended to create a method and device, which are very precise, free of erroneous operations, while nevertheless being affordable and versatile.

The aforementioned and other advantages and benefits of the invention are thus achieved in the manner stated to be characteristic in the accompanying Claims.

In the following, the invention is examined with reference to the accompanying drawings, which show schematic images of some of the properties of the present invention.

Thus:

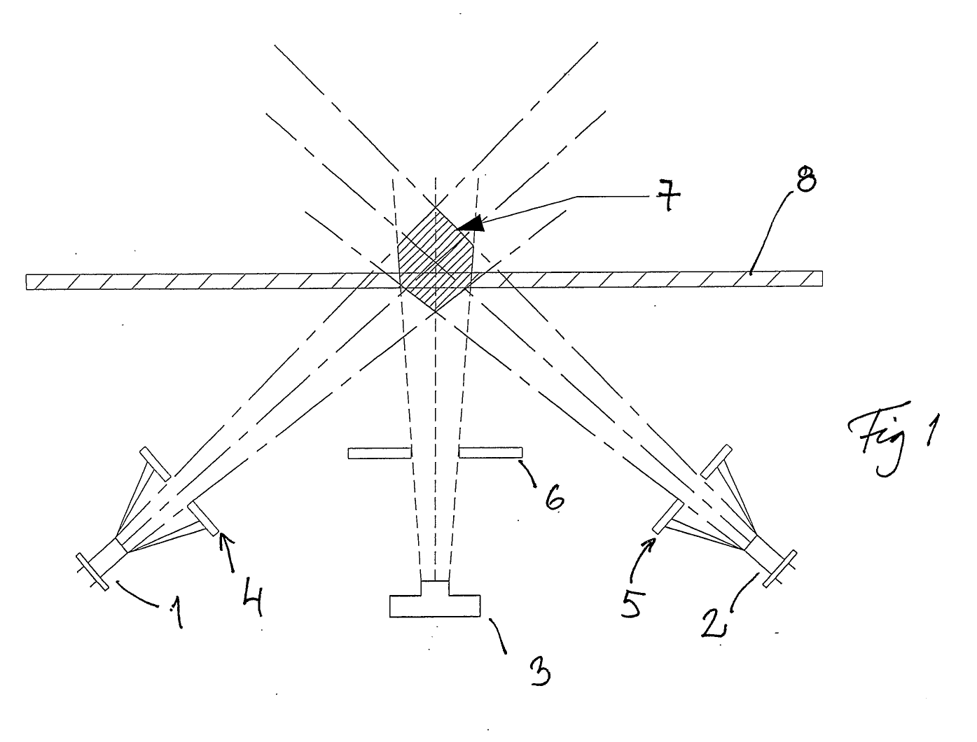

FIG. 1 shows a basic solution of one application according to the invention; and

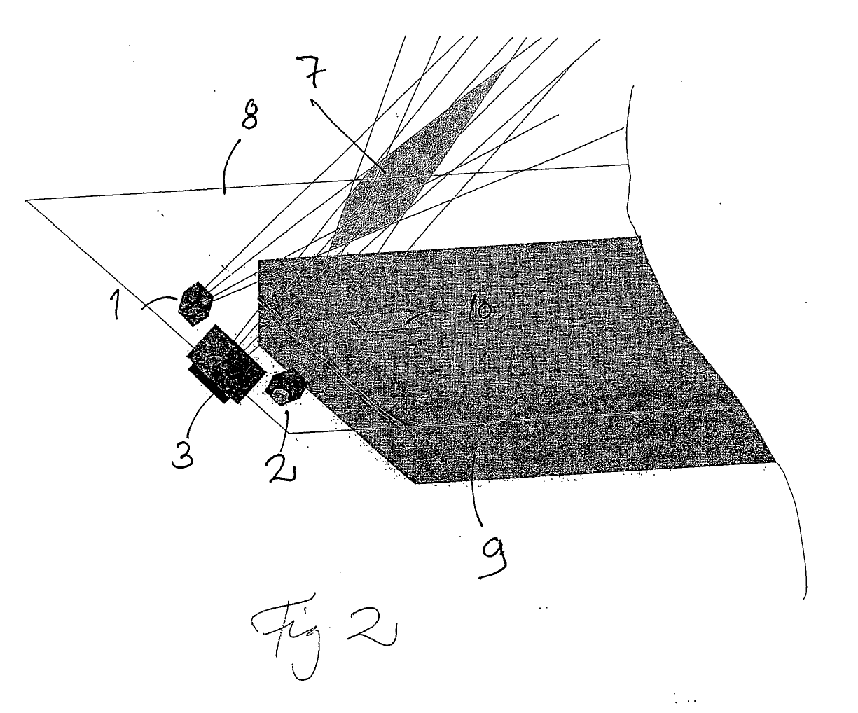

FIG. 2 shows in turn in three dimensions the implementation of the invention.

The method according to the invention will become clearly apparent from the descriptions of the accompanying pictures of the device.

FIG. 1 shows a schematic image of the device according to the invention. Thus the device consists of two IR-range light transmitting transmitter units 1 and 2 and of one unit 3 receiving the said light. The light beam from the transmitting units is restricted in a suitable manner. There are several restriction methods, in this case the manner described by way of example comprises a plate 4, 5, with a hole/gap, the light travelling through which being suitable restricted to a relatively narrow beam. The light beam coming to the receiver 3 is also suitably restricted 6. Lenses or reflectors or a suitable combination of such means can also be used, in addition to gaps for restricting, orienting, and focussing.

The surface, for example a glass plate, behind which (when seen from the light source) the desired function can, if necessary, be activated by causing a beam of reflected light in the receiver, is marked with the reference number 8.

Reference number 7 is used to mark a shaded area, which as can be clearly seen from the figure, is formed by the intersecting areas of the light beams of the light-emitting transmitters, from which the parts external to the area seen by the receiver 3 have additionally been eliminated. Thus the area, from which the desired operation is activated, is strictly limited, nor will movements taking place farther from the plate 3, for example, cause erroneous activations.

According to the invention, the light of the light-transmitting units is of a particularly specifically modulated frequency, to suit precisely the properties of the detecting sensor 3.

The light beams from the various transmitters 1, 2 are sent in different directions and transmission takes place at different periods of time. Detection may take place by bringing a finger, or other means causing light to be reflected to the shaded area in the figure. As can be clearly seen from the figure, the surface 8 need not be touched in order to create a reflection, but there is of course nothing to prevent operation in this manner, so that the surface is touched physically, in order to active the function.

FIG. 2 is intended to illustrate, how the invention can be implemented in a manner that will bring many different advantages compared to solutions according to the prior art. Thus FIG. 2 clearly shows that, in addition to the light beams sent by the light sources coming at an angle form one direction to the glass plate or similar, they also come at an angle in at least one other direction. The intersecting light beams naturally come at an angle in order to be able to intersect each other. This also takes place in a conventional solution. According to the invention, the direction of the light beams is set at an angle in at least another direction, so that a situation cannot arise relative to the plate 8, in which the light would be reflected back to the receiver, without any purpose.

Thus in practice an arrangement like that described will entirely remove the possibility that light of the light sources 1, 2 will, under any circumstances be reflected accidentally to the receiver 3. The light reflected from the surfaces will always be reflected strongly away from the receiver 3. This is the case even when there are several surfaces, such as several plate-like surfaces 8, in which the light is both reflected and refracted.

In FIG. 2 there is a panel, in which there is an icon 10 of the desired function on its upper surface, marked with the reference number 9. At its simplest, the panel can be a fixed plate-like component, on the surface of which various function symbols 10 are marked. However and possibly more likely, the panel will be, for example, a electronic panel, for instance a liquid-crystal display surface, in which the symbols appear in a virtual form. The operating point, from which by using a finger or a corresponding tool the desired function can be achieved, is located on top of the symbol 10, thus leading the user to imagine that they are pressing the symbol and thus sending the reflected light to activate the function. In this situation, the term ‘on top’ refers to the area facing the user, regardless of whether the panel is vertical or horizontal, or somewhere in between.

The transmission of light from an angle external to the panel 9 also results in the positive aspect that the entire edge of the panel is entirely available for use, without any special measures, as a location for even virtual function symbols. It is obvious that by locating the light sources and receivers on different sides of the panel 9, especially all the edge areas of the panel will be available and if desired a very large number of functions can be accessed using a relatively small panel.

The embodiment of the device according to the invention can, if desired, even be a very small ‘optical button’ of the transmitters and receiver, which can be located suitably in connection with the panel 9.

In the above, reference has only be made to infrared light in connection with the invention. However, the use of light, its transmission, reflection, and detection are similar events, regardless of the wavelength of the light. Thus the invention is in no way restricted to only infrared light. The light can be modulated in order to improve detection or to remove interfering light, or for other reasons if required, and involves conventional technology.

1. A method for touch-free operation in a system, in which there are light-transmitting and receiving components, and an essentially transparent surface between the user and the components, the method comprising the steps of:
transmitting light in at least two directions, in such a way that light beams intersect essentially at a desired location of operation,
receiving reflected light, and
a desired function is activated when the reflected light is detected, characterized in that the light beams are directed at an angle in at least two directions relative to the transparent surface.

2. A method according to claim 1, characterized in that the light is infrared-range light.

3. A method according to claim 1, characterized in that the desired location of operation is defined as the common area of the area delimited by the light beams, which are limited in extent, and the area of vision of the receiving component.

4. A method according to claim 3, characterized in that the area of intersection of the light beams is targeted mainly in an area raised above the transparent surface on a user's side of the transparent surface.

5. A method according to claim 4, further comprising a symbol showing the function to be activated is located on the surface in an area of the area that is essentially facing the light transmitter.

6. A method according to claim 1, characterized in that the light transmitter is used to transmit light in separate periods of time.

7. A device for touch-free operation, comprising;
at least two light transmitters, and
a receiver/light detector for a reflected component of the transmitted light,
an essentially transparent surface disposed between the transmitters/detector and a user, in which case the light transmitters transmit light in two different directions, in such a way that the light beams intersect at essentially the a desired operating location, characterized in that the transmitters are oriented in such a way that their light beams are at an angle relative to the surface in at least two directions.

8. A device according to claim 7, characterized in that the light transmitters are transmitters emitting infrared light.

9. A device according to claim 7, characterized in that the device also includes a symbol depicting the desired function disposed on the transparent surface, and that an operating location reflecting light is located essentially in an area of the symbol facing towards the user.

10. A device according to claim 7, characterized in that the light detector is located essentially in the area between the light transmitters, especially essentially a straight line between them.

11. A device according to claim 7, characterized in that the light transmitters and the light detector form a unified unit.

12. A device according to claim 7 characterized in that the operating location is formed as an area, which is formed by the intersection area of the light beams of the light transmitters limited to the field of vision of the light detector in the area of intersection.
